(19) United States
(12) Patent Application Publication
(10) Pub. No.: US 2009/0315999 A1
(43) Pub. Date: Dec. 24, 2009

(54) FREQUENCY COMPONENT MEASURING DEVICE

(75) Inventor: Hiroyuki Kurita, Tokyo (JP)

Correspondence Address: PATENTTM.US, P. O. BOX 82788, PORTLAND, OR, 97282-0788, US

(73) Assignee: ADVANTEST CORPORATION, Tokyo (JP)

(21) Appl. No.: 11/995,318

(22) PCT Filed: Jul. 12, 2006
(86) PCT No.: PCT/JP2006/313834

§ 371 Date: Jun. 15, 2009

(30) Foreign Application Priority Data
Jul. 26, 2005 (JP) 2005-215453

(51) Int. Cl. H04N 17/00; H04N 5/00

(52) U.S. Cl. 348/180; 348/607; 348/E17.001; 348/E05.001

(57) ABSTRACT

A frequency component measuring device formed in a simple structure and enabling a reduction in measurement time and an increase in measurement accuracy. The frequency component measuring device comprises mixers 10, 20 and local oscillators 12, 22, and the like, as a plurality of frequency changing units changing the frequencies of signals to be measured input thereto in common, and a signal processing section 40 as a signal processing unit for extracting frequency components and removing images based on signals provided after the frequencies are changed by the plurality of frequency changing units.

### TECHNICAL FIELD

The present invention relates to a frequency component measuring device which measures frequency components of an input signal in a spectrum analyzer or the like.

### BACKGROUND ART

A method of performing image removal by performing frequency conversion in three stages in a spectrum analyzer (see, for example, Patent Document 1) and a method of performing image removal by using the results of performing a frequency sweep operation a certain number of times (see, for example, Patent Document 2) are known.

### [Patent Document 1]: Japanese Patent Laid-Open No. 2000-329806 (pp. 2-4, FIGS. 1-4)

[Patent Document 2]: International publication No. 02/29426 pamphlet (pp. 10-23, FIGS. 7-22)

### DISCLOSURE OF THE INVENTION

With the method disclosed in Patent Document 1, there is a problem that since frequency conversion is performed in three stages, three mixers and band-pass filters to be inserted between the three mixers are required and the configuration is complicated.

With the method disclosed in Patent Document 2, there is a problem that since performing frequency sweep a certain number of times is required, the time for measurement of frequency components is correspondingly increased. Also, in the case of frequency sweep performed two times for an example, there is a need to input the same signal in the first cycle of frequency sweep and in the second cycle of frequency sweep. Therefore, measurement cannot be performed with accuracy on a signal having varying frequency components. Thus there is a problem that the measurement accuracy is reduced.

The present invention has been made in consideration of such points, and an object of the present invention is to provide a frequency component measuring device capable of simplifying the configuration, reducing the measurement time and improving the measurement accuracy.

To achieve the above-described object, according to the present invention, there is provided a frequency component measuring device including a plurality of frequency converting units to which a signal to be measured is input in common, and which make frequency conversions of the signal to be measured, and a signal processing unit which performs frequency component extraction and image removal based on the signals after frequency conversions made by the plurality of frequency converting units. Since frequency component extraction and image removal are performed on the basis of the results of frequency conversions made in parallel with each other with respect to the common signal to be measured, the configuration can be simplified in comparison with the conventional configuration for repeating frequency conversion through three or more stages connected in series. Also, since the need to repeat frequency sweep a plural of times is eliminated by making a plurality of frequency conversions in parallel with each other with respect to the common signal to be measured, a reduction in measurement time can be achieved and the influence of variations in the frequency components of the signal to be measured is eliminated, thereby making it possible to improve the measurement accuracy.

It is desirable that each of the frequency converting units have a mixer which mixes the signal to be measured and a local oscillation signal with each other, a local oscillator which generates the local oscillation signal, and a band-pass filter which extracts a predetermined frequency component from an output signal from the mixer, and that the central frequencies of the band-pass filters of the plurality of frequency converting units be made different from each other. In this way, the frequencies of images generated in the plurality of frequency converting operations can be made different from each other to enable discrimination between a true frequency component to be detected and an image, thus making it possible to perform frequency component extraction and image removal with reliability.

It is also desirable that when the output levels of the plurality of band-pass filters corresponding to the plurality of frequency converting units simultaneously exceed a predetermined value, the signal processing unit determine the output level as a true frequency component of the signal to be measured, and that when the output level of only one of the plurality of band-pass filters exceeds the predetermined value, the signal processing unit determine the output level as an image. In this way, frequency component extraction and image removal can be easily performed on the basis of the output levels of the plurality of band-pass filters.

It is also desirable that frequencies on one sides of the frequencies of the local oscillation signals output from the local oscillators of the plurality of frequency converting units, each higher or lower by the central frequency of the corresponding band-pass filter than the frequency of the corresponding local oscillation signal, are set equal to each other for the plurality of frequency converting units. In this way, the frequencies to be measured, that have been set in correspondence with the plurality of frequency converting units, can be set equal to each other to completely eliminate the influence of variations in frequency components and to thereby improve the measurement accuracy.

It is also desirable to further provide frequency sweeping units which sweep through predetermined ranges the frequencies of the local oscillation signals generated by the local oscillators respectively corresponding to the plurality of frequency converting units while maintaining the state where the frequencies on one sides are set equal to each other for the plurality of frequency converting units. In this way, frequency component extraction and image removal are enabled throughout the predetermined frequency ranges through which frequency sweep is to be performed.

It is also desirable to further provide a display device which displays the relationship between the frequency and the signal level of frequency components with respect to each of the frequency ranges swept by the frequency sweeping units. In this way, with a simplified arrangement, the measurement results can be displayed in a short time with high accuracy.

It is also desirable that each band-pass filter be implemented by means of a digital filter. By using a digital filter, the facility with which the central frequency and the band width and the like are changed is improved in comparison with the case of using an analog filter, thus enabling measurement according to a user's request.

It is also desirable to further provide analog-to-digital converters which convert analog signals obtained in correspondence with the plurality of frequency converting units into digital data, and it is also desirable that the signal processing unit perform frequency component extraction and image removal by calculation processing using digital data output from the analog-to-digital converters. In particular, it is desirable that each band-pass filter be implemented by means of calculation processing performed by the signal processing unit. In this way, a band-pass filter having any characteristics can be implemented more easily.

### BRIEF DESCRIPTION OF THE DRAWINGS

FIG. 1 is a diagram showing the configuration of a spectrum analyzer in one embodiment;

FIG. 2 is a diagram showing the relationship between the frequency of a local oscillation signal and the frequency of a detectable signal to be detected in the present embodiment;

FIG. 3 is a flowchart showing the procedure of operation of a spectrum analyzer which measures signal components in a predetermined frequency range while performing image removal;

FIG. 4 is a diagram for explaining a modified example, showing the relationship between the frequency of a local oscillation signal and the frequency of a detectable signal to be detected;

FIG. 5 is a diagram for explaining a modified example, showing the relationship between the frequency of a local oscillation signal and the frequency of a detectable signal to be detected; and

FIG. 6 is a diagram for explaining a modified example, showing the relationship between the frequency of a local oscillation signal and the frequency of a detectable signal to be detected.

### DESCRIPTION OF SYMBOLS

10, 20 Mixers
12, 22 Local oscillators
14, 24 Low-pass filters (LPF)
16, 26 Analog-to-digital converters (ADC)
18, 28 PLL circuits
18A, 28A Phase comparators (PD)
18B, 28B Low-pass filters
18C, 28C Variable frequency dividers
40 Signal processing section
42, 44 Band-pass filters (BPF)
50 Display device

### BEST MODE FOR CARRYING OUT THE INVENTION

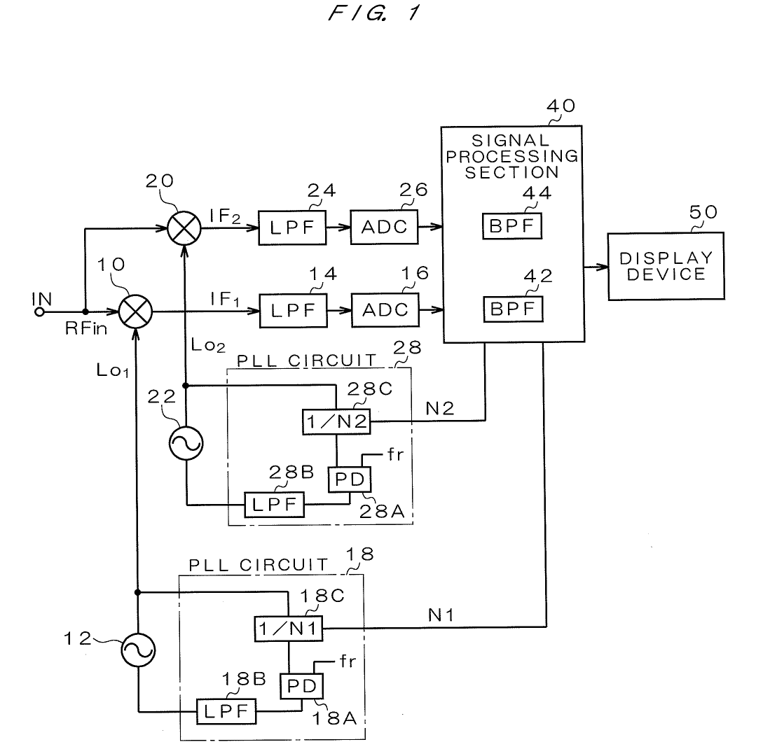

A spectrum analyzer which is a frequency component measuring device in an embodiment to which the present invention is applied will be described in detail with reference to the drawings. FIG. 1 is a diagram showing the configuration of the spectrum analyzer in an embodiment. As shown in FIG. 1, the spectrum analyzer in the present embodiment has mixers 10 and 20, local oscillators 12 and 22, low-pass filters (LPFs) 14 and 24, analog-to-digital converters (ADCs) 16 and 26, PLL circuits 18 and 28, a signal processing section 40 and a display device 50.

The mixer 10 has two input terminals, one of which is connected to a signal input terminal IN, and the other of which is connected to an output terminal of the local oscillator 12. The mixer 10 mixes the frequencies of a signal RFin to be measured which is input through the signal input terminal IN and a local oscillation signal Lo₁ which is output from the local oscillator 12 to output an intermediate frequency signal IF₁. The output signal from the mixer 10 is input to the analog-to-digital converter 16 via the low-pass filter 14. The low-pass filter 14 is for removing aliasing noise generated in sampling processing in the analog-to-digital converter 16. The low-pass filter 14 allows passage of only components of frequencies equal to or lower than a predetermined cutoff frequency lower than ½ of a sampling frequency in this sampling processing. The analog-to-digital converter 16 converts the intermediate frequency signal IF₁ after passage through the low-pass filter 14 into intermediate frequency data D_{IF1} in digital form.

Similarly, the mixer 20 has two input terminals, one of which is connected to the signal input terminal IN, and the other of which is connected to an output terminal of the local oscillator 22. The mixer 20 mixes the frequencies of the signal RFin to be measured which is input through the signal input terminal IN and a local oscillation signal Lo₂ which is output from the local oscillator 22 to output an intermediate frequency signal IF₂. The output signal from the mixer 20 is input to the analog-to-digital converter 26 via the low-pass filter 24. The low-pass filter 24 is for removing aliasing noise generated in sampling processing in the analog-to-digital converter 26. The low-pass filter 24 allows passage of only components of frequencies equal to or lower than a predetermined cutoff frequency lower than ½ of a sampling frequency in this sampling processing. The analog-to-digital converter 26 converts the intermediate frequency signal IF₂ after passage through the low-pass filter 24 into intermediate frequency data D_{IF2} in digital form.

The local oscillator 12 generates the local oscillation signal Lo₁ to be input to the one mixer 10. The phase-locked loop (PLL) circuit 18 controls the oscillation frequency of the local oscillator 12 to a predetermined value. Accordingly, the PLL circuit 18 includes a phase comparator (PD) 18A, a low-pass filter (LPF) 18B and a variable frequency divider 18C. The phase comparator 18A performs phase comparison between a reference frequency signal and a signal obtained by dividing the frequency of the local oscillation signal Lo₁ output from the local oscillator 12 by the variable frequency divider 18C, and outputs a pulse of a duty according to the comparison result. This pulse is smoothed by the low-pass filter 18B to generate a control voltage V1, which is applied to the local oscillator 12 as a voltage-controlled oscillator. The variable frequency divider 18C is capable of changing the frequency dividing ratio N1. The variable frequency divider 18C divides the frequency of the local oscillation signal Lo₁ at the frequency dividing ratio N1 and inputs the frequency-divided oscillation signal to the phase comparator 18A.

The local oscillator 22 generates the local oscillation signal Lo₂ to be input to the other mixer 20. The PLL circuit 28 controls the oscillation frequency of the local oscillator 22 to a predetermined value. Accordingly, the PLL circuit 28 includes a phase comparator (PD) 28A, a low-pass filter (LPF) 28B and a variable frequency divider 28C. The phase comparator 28A performs phase comparison between a reference frequency signal and a signal obtained by dividing the frequency of the local oscillation signal Lo₂ output from the local oscillator 22 by the variable frequency divider 28C, and outputs a pulse of a duty according to the comparison result. This pulse is smoothed by the low-pass filter 28B to generate a control voltage V2, which is applied to the local oscillator 22 as a voltage-controlled oscillator. The variable frequency divider 28C is capable of changing the frequency dividing ratio N2. The variable frequency divider 28C divides the frequency of the local oscillation signal Lo₂ at the frequency dividing ratio N2 and inputs the frequency-divided oscillation signal to the phase comparator 28A.

The signal processing section 40 is constituted by a digital signal processor (DSP) for an example. The signal processing section 40 detects frequency components of the signal RFin which is to be measured while performing image removal by using two sorts of the intermediate frequency data D_{IF1} and D_{IF2} respectively input from the two analog-to-digital converters 16 and 26. The signal processing section 40 has a band-pass filter (BPF) 42 which allows passage of particular frequency band components with respect to the intermediate frequency data D_{IF1} input from the analog-to-digital converter 16 and a band-pass filter (BPF) 44 which allows passage of particular frequency band components with respect to the intermediate frequency data D_{IF2} input from the other analog-to-digital converter 26. These two band-pass filters 42 and 44 are digital filters realized by digital calculation processing and capable of adjusting the passband width and the central frequency within predetermined ranges. Also, the signal processing section 40 performs such frequency sweep control that the frequencies of the local oscillation signals Lo₁ and Lo₂ respectively output from the two local oscillators 12 and 22 are increased or decreased in relation with each other, by simultaneously changing the frequency dividing ratio N1 of the variable frequency divider 18C in the PLL circuit 18 and the frequency dividing ratio N2 of the variable frequency divider 28C in the PLL circuit 28.

The display device 50 displays the results of detection of frequency components of the detected signal RFin detected by the signal processing section 40. For an example, display is performed by indicating the frequency on the abscissa and the signal level on the ordinate with respect to the frequency components.

The above-described mixers 10 and 20, local oscillators 12 and 22 and band-pass filters 42 and 44 correspond to the frequency conversion unit, and the signal processing section 40 corresponds to the signal processing unit. Also, the PLL circuits 18 and 28 correspond to the frequency sweep unit.

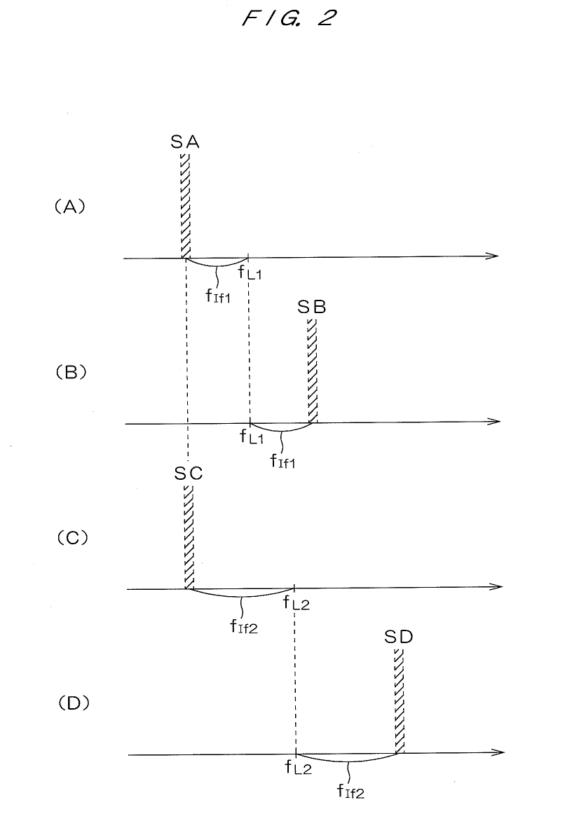

The spectrum analyzer in the present embodiment has the above-described configuration. The operation to measure the frequency components of the detected signal RFin while performing image removal will now be described. FIG. 2 is a diagram showing the relationship between the frequencies of the local oscillation signals and the detectable frequency of the detected signal Rfin according to the present embodiment. In (A) and (B) of FIG. 2, the relationship corresponding to the combination of the mixer 10 and the local oscillator 12 is shown. In (C) and (D) of FIG. 2, the relationship corresponding to the combination of the other mixer 20 and the other local oscillator 22 is shown.

As to the combination of the mixer 10 and the local oscillator 12, the central frequency of the corresponding band-pass filter 42 in the signal processing section 40 is set to f_{IF1}, and detection of a signal component SA of a frequency lower by f_{IF1} than the frequency f_{L1} of the local oscillation signal Lo₁ output from the local oscillator 12 is performed (FIG. 2(A)). In actuality, however, a signal component SB of a frequency higher by f_{IF1} than the frequency f_{L1} of the local oscillation signal Lo₁ is also detected (FIG. 2(B)). This signal component SB is mixed in as an image.

Similarly, as to the combination of the mixer 20 and the local oscillator 22, the central frequency of the corresponding band-pass filter 44 in the signal processing section 40 is set to f_{IF2}, and detection of a signal component SC of a frequency lower by f_{IF2} than the frequency f_{L2} of the local oscillation signal Lo₂ output from the local oscillator 22 is performed (FIG. 2(C)). In actuality, however, a signal component SD of a frequency higher by f_{IF2} than the frequency f_{L2} of the local oscillation signal Lo₂ is also detected (FIG. 2(D)). This signal component SD is mixed in as an image.

In the present embodiment, image removal is performed by adjusting the frequency of the signal component SA shown in FIG. 2(A) and the frequency of the signal component SC shown in FIG. 2(C) to be equal to each other. That is, when the output from the band-pass filter 42 in the signal processing section 40 has a certain level, the cause of this is thought to be one of two cases: a case where the true signal component SA to be detected exists, and a case where the signal component SB as an image exists. Similarly, when the output from the band-pass filter 44 in the signal processing section 40 has a certain level, the cause of this is thought to be one of two cases: a case where the true signal component SC to be detected exists, and a case where the signal component SD as an image exists. Since the frequencies of the signal component SA and the signal component SC are equal to each other, these two signal components SA and SC are identical to each other and, if the outputs from the two band-pass filters 42 and 44 simultaneously exhibit a certain level (the cases shown in FIGS. 2(A) and 2(C)), the true signal component to be detected exists. If only the output from the one band-pass filter 42 exhibits a certain level (the case shown in FIG. 2(B)), an image of a frequency higher by f_{IF1} than the frequency f_{L1} of the local oscillation signal Lo₁ exists. If only the output from the other band-pass filter 44 exhibits a certain level (the case shown in FIG. 2(D)), an image of a frequency higher by f_{IF2} than the frequency f_{L2} of the local oscillation signal Lo₂ exists.

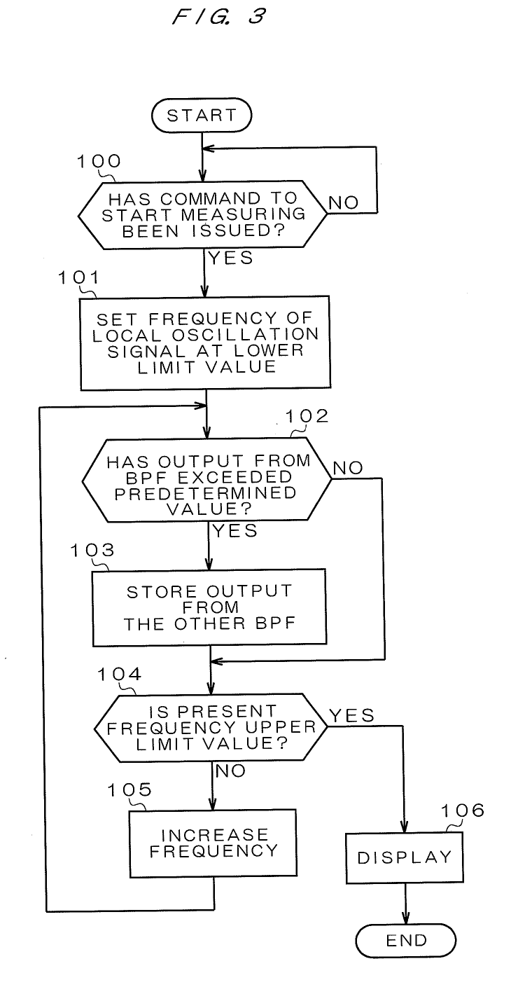

FIG. 3 is a flowchart showing the procedure of operation of the spectrum analyzer in the present embodiment when the spectrum analyzer measures signal components in a predetermined frequency range while performing image removal. The signal processing section 40 determines whether or not a command to start measuring signal components has been issued (step 100). If no command is issued, the signal processing section 40 makes a negative determination and repeats this determination.

If a predetermined measurement starting operation is performed by a user while a signal RFin which is to be measured is being input to the signal input terminal IN, an affirmative determination is made in determination in step 100. Subsequently, the signal processing section 40 sets each of the frequency dividing ratio N1 of the variable frequency divider 18C in the PLL circuit 18 and the frequency dividing ratio N2 of the variable frequency divider 28C in the PLL circuit 28 to a value according to the lower limit frequency of frequency sweep (step 101). For example, the frequency dividing ratio N1 of the variable frequency divider 18C is set so that if the lower limit frequency of frequency sweep is f_{MIN}, f_{L1}=f_{MIN}+f_{IF1} in order to satisfy the relationship shown in FIG. 2(A). Also, the frequency dividing ratio N2 of the variable frequency divider 28C is set so that f_{L2}=f_{MIN}+f_{IF2} in order to satisfy the relationship shown in FIG. 2(C). In this state, the signal processing section 40 determines whether or not the output from the one band-pass filter 42 has exceeded a predetermined value (step 102). If this output has exceeded the predetermined value, an affirmative determination is made and the signal processing section 40 takes in the output value of the other band-pass filter 44 and stores the output value together with the sweep frequency at that time (step 103).

Subsequently, or if the output from the band-pass filter 42 has not exceeded the predetermined value, a negative determination is made in the step 102. The signal processing section 40 thereafter determines whether or not the present frequency is equal to the upper limit value of frequency sweep (step 104). If the present frequency has not reached the upper limit value, a negative determination is made and the signal processing section 40 subsequently increases the sweep frequency by a predetermined value (step 105). For an example, each of the values of the frequency dividing ratios N1 and N2 of the variable frequency dividers 18C and 28C is updated by adding “1” thereto. The sweep frequency is thereby increased by the frequency fr of the reference frequency signal. The state in which the frequency of the signal component SA shown in FIG. 2(A) and the frequency of the signal component SC shown in FIG. 2(C) are equal to each other can be maintained by equalizing the amounts Δf by which the two local oscillation signals Lo₁ and Lo₂ are increased. A return to step 102 is then made to repeat the processing.

If the sweep frequency has reached the upper limit value, an affirmative determination is made in the step 104 and the signal processing section 40 subsequently reads out the output value stored in the step 103 and displays the measurement results by indicating the sweep frequency on the abscissa and indicating the signal level of each frequency component on the ordinate (step 106). Thus, the measurement sequence with respect to the signal RFin to be measured is completed.

Thus, in the spectrum analyzer in the present embodiment, the levels of signal components passed through two band-pass filters 42 and 44 are observed, the existence of a true signal component is determined when both the output values increase simultaneously, and an image can be recognized and rejected when only one of the output values increases. Also, detection of a true signal component in a predetermined frequency range along with removal of an image can be achieved by sweeping the frequencies f_{L1} and f_{L2} of the two local oscillation signals Lo₁ and Lo₂ in one direction while maintaining the state in which the frequencies of the signal components SA and SB are equal to each other. In particular, since it is sufficient that only two frequency conversions made in parallel, the configuration can therefore be simplified in comparison with the conventional configuration for repeating frequency conversion through three or more stages connected in series. Also, since a plurality of frequency conversions are made in parallel with respect to a common signal to be measured, and since there is, therefore, no need to repeat frequency sweep a plural of times, a reduction in measurement time can be achieved. This is accompanied with elimination of the influence of variations in the frequency components of the signal to be measured, thereby making it possible to improve the measurement accuracy.

The present invention is not limited to the above-described embodiment. Various modifications can be made to the described embodiment without departing from the gist of the invention. While a set of two mixers and at set of two local oscillators are used in the above-described embodiment, a set or three or more mixers and a set of three or more local oscillators may alternatively be used.

While in the above-described embodiment the signal processing section 40 also controls frequency sweep, a control section constituted by a CPU or the like may be provided separately from the signal processing section 40 constituted by a DSP or the like and this control section may control the overall operation of the spectrum analyzer including frequency sweep.

While in the above-described embodiment the output value of the one band-pass filter 44 is stored as a measurement result when the output from the other band-pass filter 42 exceeds a predetermined value as shown in the flowchart of FIG. 3, the output value of one of the two band-pass filters 42 and 44 may be stored as a measured value when both the output values of the two band-pass filters 42 and 44 exceed the predetermined value, or the average of the outputs from the two band-pass filters may be stored as a measured value.

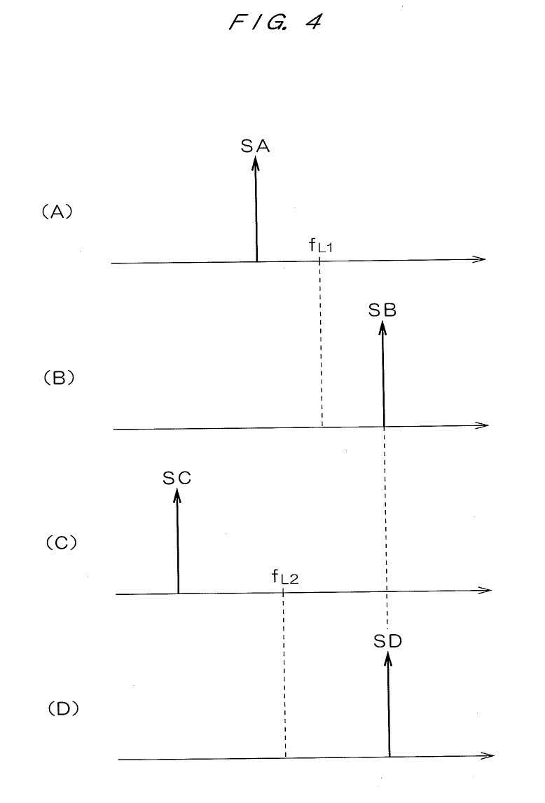

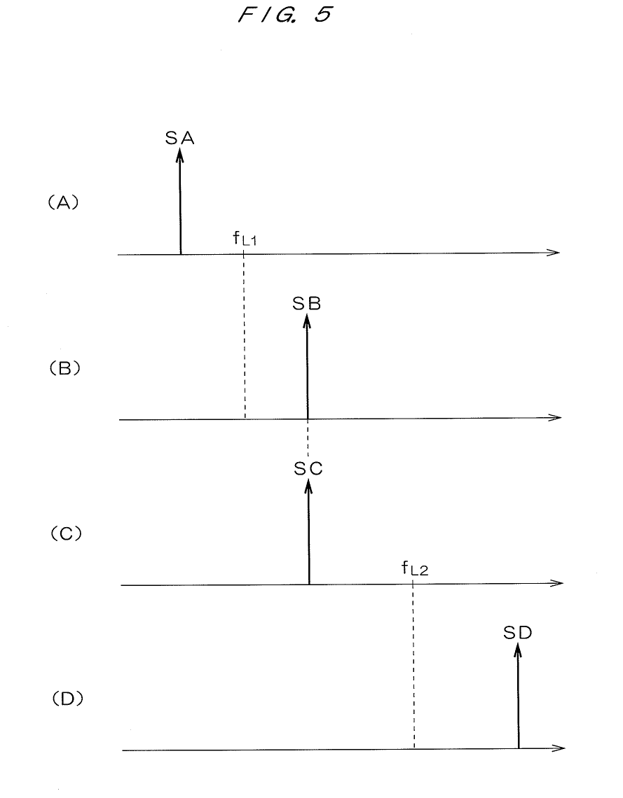

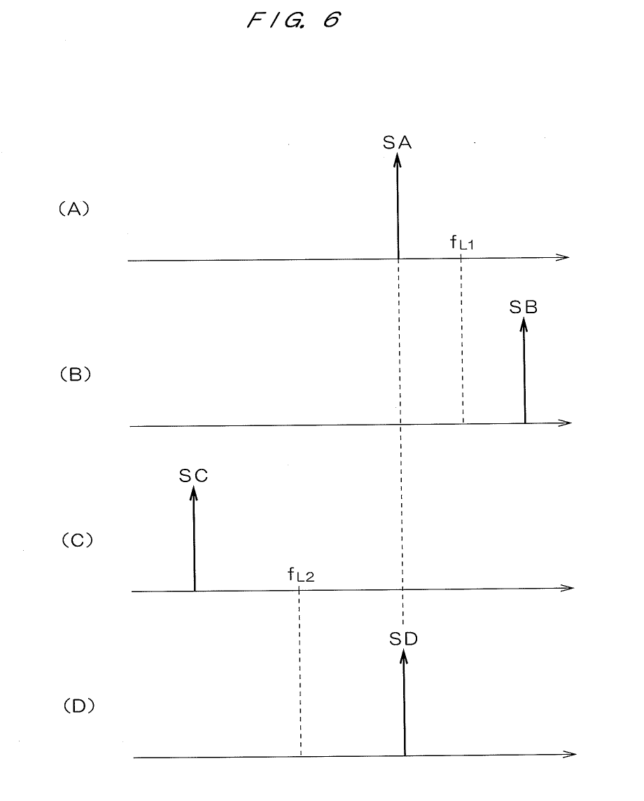

While in the above-described embodiment the frequencies of the signal components SA and SC lower than the frequencies f_{L1} and f_{L2} of the two local oscillation signals Lo₁ and Lo₂ are set equal to each other, the present invention may also be applied with respect to other combinations. For example, as shown in FIG. 4, the frequency of a signal component SB higher than the frequency f_{L1} of the one local oscillation signal Lo₁ and the frequency of a signal component SD higher than the frequency f_{L2} of the other local oscillation signal Lo₂ may be set equal to each other and the existence of a true signal component may be determined when the two signal components SB and SD are detected simultaneously with each other. Also, as shown in FIG. 5, the frequency of a signal component SB higher than the frequency f_{L1} of the one local oscillation signal Lo₁ and the frequency of a signal component SC lower than the frequency f_{L2} of the other local oscillation signal Lo₂ may be set equal to each other and the existence of a true signal component may be determined when the two signal components SB and SC are detected simultaneously with each other. Also, as shown in FIG. 6, the frequency of a signal component SA lower than the frequency f_{L1} of the one local oscillation signal Lo₁ and the frequency of a signal component SD higher than the frequency f_{L2} of the other local oscillation signal Lo₂ may be set equal to each other and the existence of a true signal component may be determined when the two signal components SA and SD are detected simultaneously with each other.

While the embodiment has been described with respect to an application of the present invention to a spectrum analyzer, the present invention may be applied to measurement of frequency components of a detected signal RFin in a device other than the spectrum analyzer.

While in the above-described embodiment the band-pass filters 42 and 44 are provided in the signal processing section 40, band-pass filters constituted by digital filters may alternatively be provided between the analog-to-digital converters 16, 26 and the signal processing section 40, or band-pass filters constituted by analog circuits may alternatively be provided between the mixers 10, 20 and the low-pass filters 14, 24.

### INDUSTRIAL APPLICABILITY

According to the present invention, extraction of frequency components and image removal are performed on the basis of the results of frequency conversions made in parallel with each other with respect to a signal to be measured. The configuration can therefore be simplified in comparison with the conventional configuration for repeating frequency conversion through three or more stages connected in series. Also, since the need to repeat frequency sweep a plural of times is eliminated by making a plurality of frequency conversions in parallel with each other with respect to a common signal to be measured, a reduction in measurement time can be achieved and the influence of variations in the frequency components of the signal to be measured is eliminated, thereby making it possible to improve the measurement accuracy.

1. A frequency component measuring device comprising:
a plurality of frequency converting units to which a signal to be measured is input in common, and which make frequency conversions of the signal to be measured; and
a signal processing unit which performs frequency component extraction and image removal based on the signals after frequency conversions made by the plurality of frequency converting units.

2. The frequency component measuring device according to claim 1, wherein each of the frequency converting units has a mixer which mixes the signal to be measured and a local oscillation signal, a local oscillator which generates the local oscillation signal, and a band-pass filter which extracts a predetermined frequency component from an output signal from the mixer, and
wherein the central frequencies of the band-pass filters of the plurality of frequency converting units are made different from each other.

3. The frequency component measuring device according to claim 2, wherein when the output levels of the plurality of band-pass filters corresponding to the plurality of frequency converting units simultaneously exceed a predetermined value, the signal processing unit determines the output level as a true frequency component of the signal to be measured; and, when the output level of only one of the plurality of band-pass filters exceeds the predetermined value, the signal processing unit determines the output level as an image.

4. The frequency component measuring device according to claim 3, wherein frequencies on one sides of the frequencies of the local oscillation signals output from the local oscillators of the plurality of frequency converting units, each higher or lower by the central frequency of the corresponding band-pass filter than the frequency of the corresponding local oscillation signal, are set equal to each other for the plurality of frequency converting units.

5. The frequency component measuring device according to claim 4, further comprising frequency sweeping units which sweep through predetermined ranges the frequencies of the local oscillation signals generated by the local oscillators respectively corresponding to the plurality of frequency converting units while maintaining the state where the frequencies on one sides are set equal to each other for the plurality of frequency converting units.

6. The frequency component measuring device according to claim 5, further comprising a display device which displays the relationship between the frequency and the signal level of frequency components with respect to each of the frequency ranges swept by the frequency sweeping units.

7. The frequency component measuring device according to claim 2, wherein each band-pass filter is implemented by means of a digital filter.

8. The frequency component measuring device according to claim 2, further comprising analog-to-digital converters which convert analog signals obtained in correspondence with the plurality of frequency converting units into digital data,
wherein the signal processing unit performs the frequency component extraction and the image removal by calculating processing using digital data output from the analog-to-digital converters.

9. The frequency component measuring device according to claim 8, wherein each band-pass filter is implemented by means of calculating processing performed by the signal processing unit.
